(19) United States
(12) Patent Application Publication
(10) Pub. No.: US 2014/0050123 A1
(43) Pub. Date: Feb. 20, 2014

(54) COMMUNICATIONS SYSTEM INCLUDING VOIP BRIDGE RADIO PROVIDING CHANNEL DESIGNATION FEATURES AND RELATED METHODS

(71) Applicants: DAVID CHANDLER, San Diego, CA (US); DAVID BROWN, Carlsbad, CA (US)

(72) Inventors: DAVID CHANDLER, San Diego, CA (US); DAVID BROWN, Carlsbad, CA (US)

(73) Assignee: HARRIS CORP, Melbourne, FL (US)

(21) Appl. No.: 13/588,188

(22) Filed: Aug. 17, 2012

(51) Int. Cl. H04W 4/10; H04W 4/06; H04W 72/04

(52) U.S. Cl. 370/260; 370/329; 370/277

(57) ABSTRACT

A communications system includes a Voice over IP (VoIP) device, a plurality of radios each configured to communicate using a plurality of different radio channels, and a bridge radio. The bridge radio includes a VoIP interface configured to communicate with the VoIP device, a radio interface configured to communicate with the radios, and a controller coupled to the VoIP interface and the radio interface. The controller is configured to receive a communication request from the VoIP device to communicate via a given radio channel. The communication request includes an IP address associated with the bridge radio and a channel identifier associated with the given radio channel. The controller also bridges communications between the VoIP device and at least one of the radios over the given radio channel based upon the received communication request.

### FIELD OF THE INVENTION

The present invention relates to the field of communications, and, more particularly, to wireless communications system and related methods.

### BACKGROUND OF THE INVENTION

With advances in processing capabilities and programming technologies, software defined mobile wireless communications devices (e.g., radios) continue to increase in popularity. Rather than relying upon hardware and circuitry components to perform frequency, modulation, bandwidth, security, and/or waveform functions, these functions are instead performed by software modules or components in a software radio. That is, with a software radio analog signals are converted into the digital domain where the above-noted functions are performed using digital signal processing based upon software modules.

Because most of the functions of the radio are controlled by software, software radios may typically be implemented with relatively standard processor and hardware components. This may not only reduce device hardware costs, but it also provides greater flexibility in upgrading the device since new communications waveform modules can be uploaded to the device relatively easily and without the need to interchange new hardware components.

One particularly advantageous software radio is the Falcon III® AN/PRC-152 Type-1 Handheld Multiband Radio from the present Assignee, Harris Corporation of Melbourne, Fla. The Falcon III® AN/PRC-152 is a 30-512 MHz multiband handheld radio which provides a high band option extending frequency range coverage to 30-520 MHz and 762-870 MHz. The Falcon III® radio provides Sierra™ programmable encryption and supports SINCGARS, VHF/UHF AM and FM, and optional HAVEQUICK formats. Optional APCO-P25 waveform operation allows for interoperability with various networks. The Falcon III® radio also includes a hardware configuration option, including an embedded GPS receiver for situational awareness.

A potential difficulty with radio networks may arise when communicating with many different targets or peers at the same time. As such, enhanced multi-channel operating features may be desirable in some implementations.

### SUMMARY OF THE INVENTION

In view of the foregoing, it is an object of the invention to provide a system and related methods with enhanced multi-channel operating features for radio networks.

A communications system includes a Voice over IP (VoIP) device, a plurality of radios each configured to communicate using a plurality of different radio channels, and a bridge radio. The bridge radio includes a VoIP interface configured to communicate with the VoIP device, a radio interface configured to communicate with the radios, and a controller coupled to the VoIP interface and the radio interface. The controller is configured to receive a communication request from the VoIP device to communicate via a given radio channel. The communication request includes an IP address associated with the bridge radio and a channel identifier associated with the given radio channel. The controller also bridges communications between the VoIP device and at least one of the radios over the given radio channel based upon the received communication request. Accordingly, the system provides a flexible and configurable approach for communicating with desired peer devices or groups over a VoIP interface through a requested channel designation.

More particularly, the controller may be configured to operate the radio interface using a subset of the plurality of radio channels, and to selectively change the subset of channels based upon the channel identifier associated with the communication request. The plurality of radios may be configured in call groups, where each call group shares a common radio channel so that communication therewith is party line communication. The VoIP device may comprise a Session Initiation Protocol (SIP) device, for example. The VoIP device may comprise another bridge radio in some embodiments.

The radio and the radio interface may be configured to operate in a half duplex mode, for example. Furthermore, the IP address may be appended to the channel identifier within the communication request. Additionally, the bridged communications between the VoIP device and the at least one radio may comprise voice data and/or multimedia session data. The radio and the radio interface may be configured to operate using single frequency and frequency hopping modes, for example.

A related bridge radio, such as the one described briefly above, and a related method for bridging communications between a VoIP device and a plurality of radios using a plurality of different radio channels are also provided. The method includes receiving, at a bridge radio, a communication request from the VoIP device to communicate via a given radio channel, where the communication request includes an IP address associated with the bridge radio and a channel identifier associated with the given radio channel. The method further includes bridging communications between the VoIP device and at least one of the radios over the given radio channel using the bridge radio based upon the received communication request.

### BRIEF DESCRIPTION OF THE DRAWINGS

FIG. 1 is a schematic block diagram of a communications system in accordance with the invention including a bridge radio for providing VoIP communication to selected radio call groups.

FIG. 2 is a schematic block diagram of an embodiment of the bridge radio of FIG. 1.

FIG. 3 is a flow diagram illustrating method aspects associated with the system of FIG. 1.

FIG. 4 is a schematic block diagram of another embodiment of the communications system of FIG. 1 in which multiple VoIP peers communicate with respective radio call groups.

FIG. 5 is a schematic block diagram of still another embodiment of the communications system of FIG. 1 in which a bridge radio bridges different radio networks to crosstalk with respective radio call groups via VoIP connections.

FIGS. 6 and 7 are schematic block diagrams illustrating logical call groups from the communications system of FIG. 3.

FIGS. 8-11 are a series of schematic block diagrams of a communications system in accordance with the invention illustrating dynamic call group assignment by the bridge radio.

FIG. 12 is a schematic block diagram of a bridge radio and associated radio call groups illustrating communication request formatting in accordance with the invention.

FIGS. 13 and 14 are display views of a VoIP peer device display and a bridge radio display respectively illustrating phone book selection and call monitoring functions in the system of FIG. 12.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

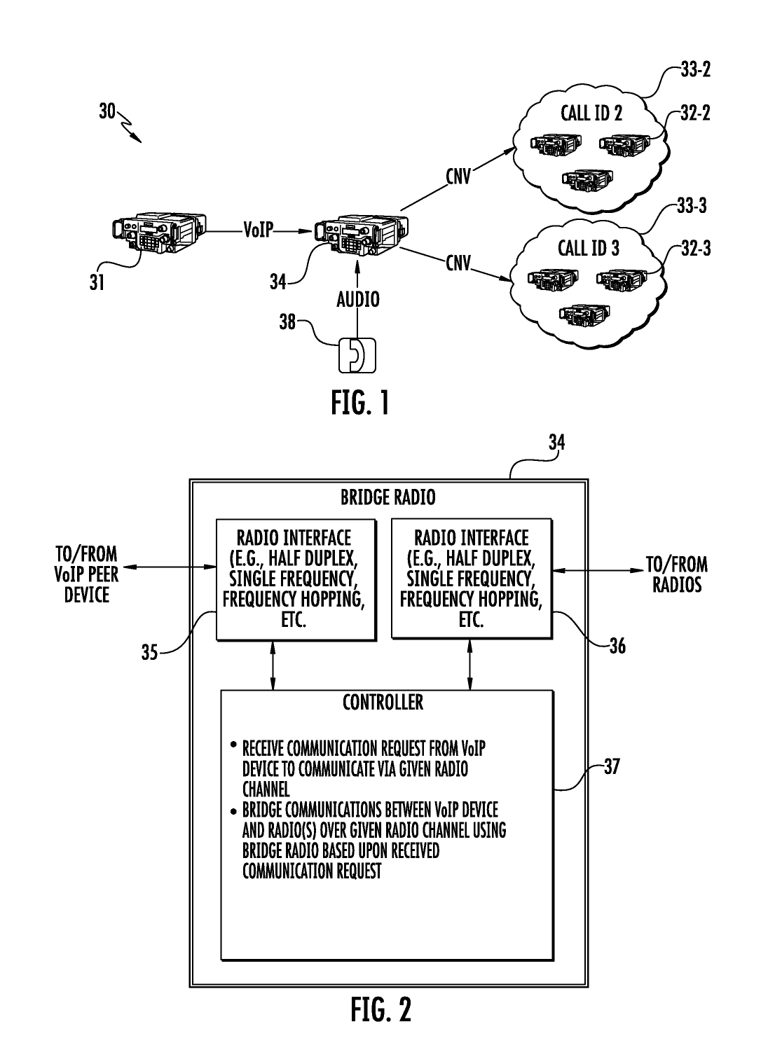

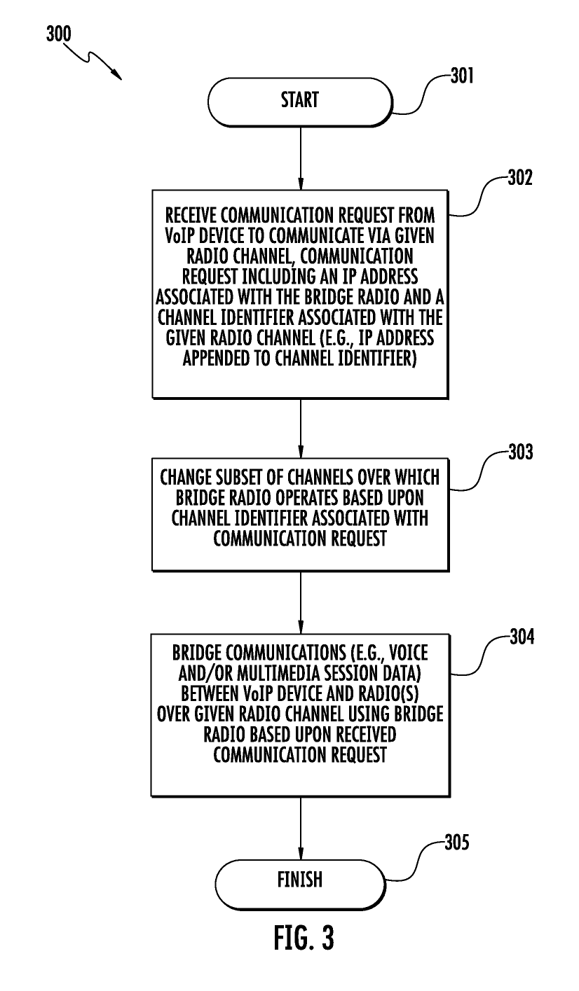

Referring initially to FIGS. 1 and 2, and the flow diagram 300 of FIG. 3, a communications system 30 and associated method aspects are first described. The system 30 illustratively includes a Voice over IP (VoIP) device 31, which is also referred to as a VoIP peer device herein. The system 30 further illustratively includes a plurality of radios 32-2, 32-3, which are organized into respective call groups 33-2, 33-3 and illustrated as clouds in the drawings. The radios 32-3, 32-3 are each configured to communicate using a plurality of different radio channels, and the call groups 33-2, 33-3 result from the radios communicating on a same channel. That is, the radios 32-2 are communicating via channel 2 (Call ID 2), and are therefore in the call group 33-2, etc.

The system 30 further illustratively includes a bridge radio 34, which includes a VoIP interface 35 configured to communicate with the VoIP device 31 over a VoIP network, a radio interface 36 configured to communicate with the radios 32-2, 32-3, and a controller 37 coupled to the VoIP interface and the radio interface. In the present example, a handset 38 is connected to the bridge radio 34 so that it may also be used as a point of audio communication with the radios 32-2, 32-3 and/or the VoIP peer device 31, for example, although a handset need not be used with the bridge radio in all embodiments.

Each call group 33-2, 33-3 shares a common radio channel (i.e., a Call ID) so that communication among the radios with a respective call group is party line communication. The radios 32-2, 32-3 are typically configured to operate in a half duplex mode, for example. The radios 32-2, 32-3 and the radio interface 36 may be configured to operate using single frequency and frequency hopping modes, for example. By way of example, the radio interface 36 may include one or more wireless transceivers for communicating via the various Call IDs.

Beginning at Block 301, the controller 37 is configured to receive a communication request from the VoIP device 31 to communicate via a given radio channel, at Block 302. As will be discussed further below, the communication request includes an IP address associated with the bridge radio 34 and a channel identifier associated with the given radio channel. The controller 37 bridges communications between the VoIP device 31 and one or more of the radios 32-2, 32-3 over the given radio channel based upon the received communication request, at Block 304. The bridged communications between the VoIP peer device 31 and the at least one radio may include voice data and/or multimedia session data, for example. As will also be described further below, the controller 37 may optionally be configured to operate the radio interface using a subset of the plurality of radio channels, and to selectively change the subset of channels based upon the channel identifier associated with the communication request, at Block 303. The method illustrated in FIG. 3 is concluded at Block 305.

In the illustrated example, the radio interface 36 and radios 32-2, 32-3 are configured to operate in accordance with Joint Tactical Radio System (JTRS) standards using a Soldier Radio Waveform (SRW) format, although other radio formats or configurations may also be used. By way of background, SRW is functionally a multi-channel waveform for voice. In SRW, voice traffic is assigned a Call ID, and each SRW radio may process up to five such streams at a time. As such, the SRW radio may replace up to five radios by operating on five different simultaneous independent voice nets under a single RF net.

However, with a single handset, it may otherwise be difficult to provide a user interface that effectively takes advantage of multiple simultaneous voice nets. Delivery of too many simultaneous streams to the same handset speaker may make it difficult for the user to understand anything through the cacophony. Yet, delivery of too few channels may result in important information not being delivered.

The system 30 advantageously one or more VoIP peer devices 31 to selectively join the call groups 33-3, 33-3, so that it may effectively operate and communicate just like the radios 32-3, 32-3 in the given call group. By way of example, in a typical multi-radio installation with intercom systems, multiple operators may sit at stations with radio headsets connected to the intercom that are switched to select a desired voice net. However, in the system 30, the bridge radio 34 advantageously allows commercial off-the-shelf (COTS) VoIP devices such as phones, etc., or VoIP enabled radios to take the place of the intercom, allowing operators at multiple stations to select and participate in different voice nets, all of which are bridged through the bridge radio.

VoIP allows two networked radios to share a voice connection. Benefits of the VoIP include communication beyond line of sight (e.g., over the Internet, etc.). Moreover, VoIP may provide for simplified crossbanding, in that different networked waveforms (e.g., ANW2, SRW, SINCGARS, etc.) may communicate with other network waveform devices through bridging of the dissimilar voice nets, as will be discussed further below. Moreover, VoIP devices may allow for full duplex communication, and are readily available as COTS devices (e.g., SIP Phones, etc.).

In the system 30, the VoIP peer device 31 advantageously hears what the local handset operator in a given call group 33-2, 33-3 hears. When the VoIP interface 35 of the bridge radio 34 receives VoIP data, the controller 37 will “repackage” the data as voice net data and forward it to the desired voice net call group(s) 33-2, 33-3 as if the VoIP peer device were a local radio 32-3, 32-3 that had keyed to speak in the respective call group. Thus, the VoIP peer device 31 may conceptually be considered as an extended or remote handset of the bridge radio 34.

With respect to SRW, the bridge radio 34 is configured to communicate with one out of a subset of five possible Call IDs, where the given subset of five Call IDs is selected from among a larger group of available channels. The bridge radio 34 advantageously allows the VoIP call from the VoIP peer device 31 to be connected directly to a particular Call ID. In the example of FIG. 1, the bridge radio 34 Tx CallGroup is configured to be 3. The VoIP peer device 31 requests a call to be forwarded to the radios 33-2 at Call ID 2 (i.e., in the call group 33-2). The bridge radio 34 may simultaneously deliver its local user's data to Call ID 3, and its VoIP peer data to Call ID 2, which effectively makes the VoIP peer device 31 a second handset to the bridge radio.

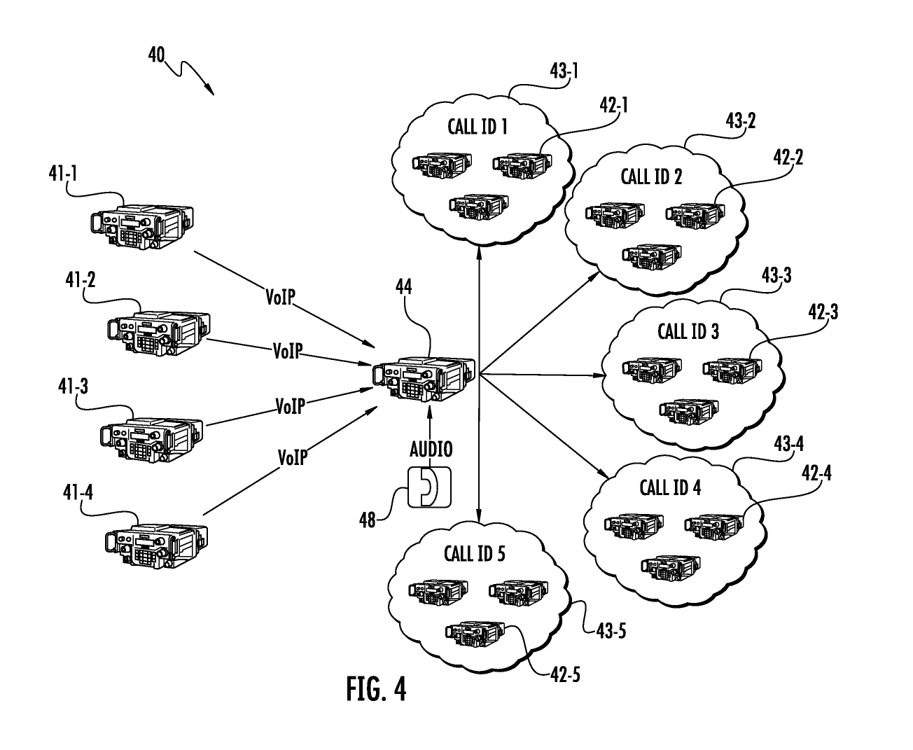

Referring to FIG. 4, another communications system 40 illustratively includes a plurality of VoIP peer devices 41-1, 41-2, 41-3, 41-4, a bridge radio 44 with associated handset 48, and radios 42-1, 42-2, 42-3, 42-4, 42-5 operating in respective call groups 43-1, 43-2, 43-3, 43-4, 43-5, which are similar to those components described above with respect to FIG. 1. When multiple VoIP Calls are placed at the same time from the VoIP peer devices 41-1, 41-2, 41-3, 41-4, these VoIP devices effectively provide still further handsets for the bridge radio 44. Here again, the VoIP peer devices 41-1, 41-2, 41-3, 41-4 may advantageously be COTS VoIP devices, and need not be designated SRW handsets, for example.

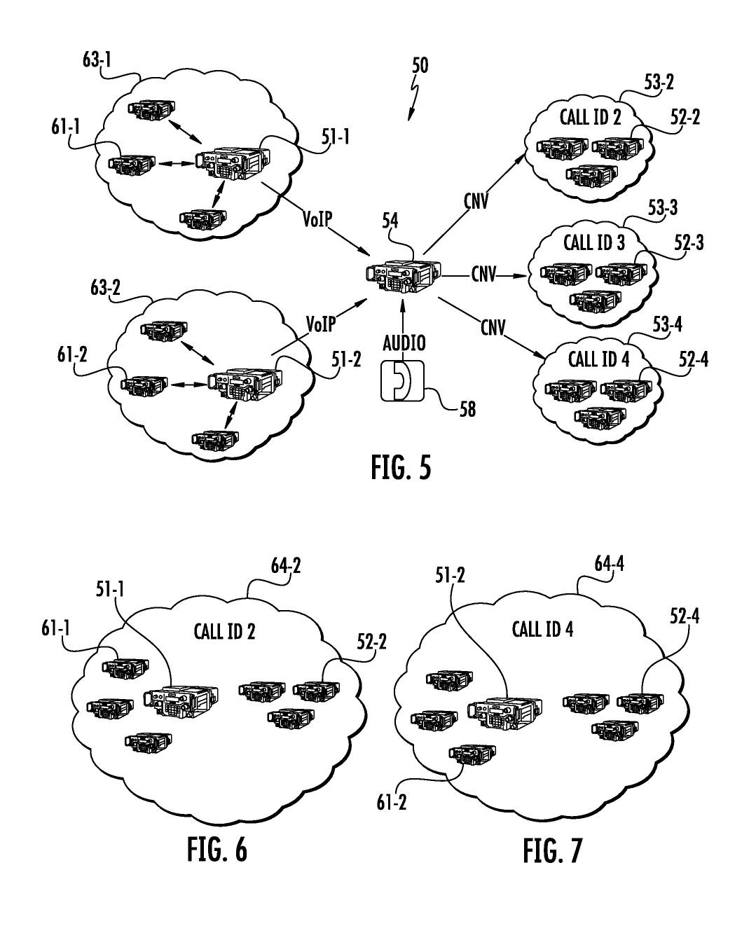

Referring now to FIGS. 5-7, another similar communications system 50 illustratively includes a network 63-1 including radios 61-1 and a bridge radio 51-1, as well as a 2 network 63-2 including radios 61-2 and a bridge radio 51-2. The system 50 further illustratively includes a bridge radio 54 with associated handset 58, and radios 52-2, 52-3, 52-4, 52-5 operating in respective call groups 53-2, 53-3, 53-4, 53-5, which are similar to those components described above. As such, this implementation goes beyond allowing additional handsets to be added to the bridge radio 54 through the use of VoIP. That is, the bridge radios 51-1, 51-2 serve as VoIP peer devices that provide a bridge between different call groups or networks. Moreover, this advantageously allows different voice network or waveforms to be interconnected. By way of example, the network 63-1 may be an ANW2 network, the network 63-2 may be a SINCGARS network, and the call groups 53-2, 53-3, 53-4, 53-5 may operate in accordance with SRW, as described above, although other formats and configurations may also be used.

Stated alternatively, through the bridge radio 54, multiple waveforms may be cross-banded with the SRW radios in the call groups 53-2, 53-3, 53-4, 53-5, which may be considered as “crosstalk”, as opposed to traditional single channel cross-banding. In the illustrated example, the ANW2 network 63-1 is being cross-banded with the SRW radios 52-2 on Call ID 2, as represented by a logical network 64-2 shown in FIG. 6. Similarly, the SINCGARS Network 63-2 is being cross-banded with the SRW radios 52-4 in Call ID 4, as represented by a logical network 64-4 shown in FIG. 7. This is all done through the SRW bridge radio 54. Moreover, the data streams are independent of one another. That is, speech on Call ID 4 does not interfere with speech on Call ID 2.

Another way to consider this approach is that the SRW Call IDs have been extended to include other waveform networks. The radios 61-2 in the SINCGARS network 63-2 may be treated the same as the SRW radios 52-4 in Call ID 4, and all of the radios 61-1 in the ANW2 network 63-1 may be treated exactly the same as the SRW radios 52-2 in Call ID 2. As such, one bridge radio 54 may act as a bridge to multiple different voice networks at the same time. With respect to SRW, this allows for true multi-channel voice waveform operation without the above-described drawbacks of prior implementations.

Turning now to FIGS. 8-11, an approach for automated dynamic call group assignment is now described with reference to another similar communications system 80. At an initial time, an SRW bridge radio 84 communicates with SRW radios 82-1 in a call group 83-1 on Call ID1. The bridge radio 84 and radios 82-1 may support up to five different simultaneous call IDs, although the radios need not necessarily be configured to use all five frequencies. To reduce the confusion that results from hearing radios that a user cannot speak with, the radios 82-1 may be configured to support one Call ID at a time, for example, although they may be configured to support multiple Call IDs at a time in some embodiments.

In FIG. 8, the bridge radio 84 has a first slot assigned to Call ID1, and the remaining four slots are unassigned as follows:
Tx Call Group: 1
Slot 1: Call ID1
Slot 2: Unassigned
Slot 3: Unassigned
Slot 4: Unassigned
Slot 5: Unassigned

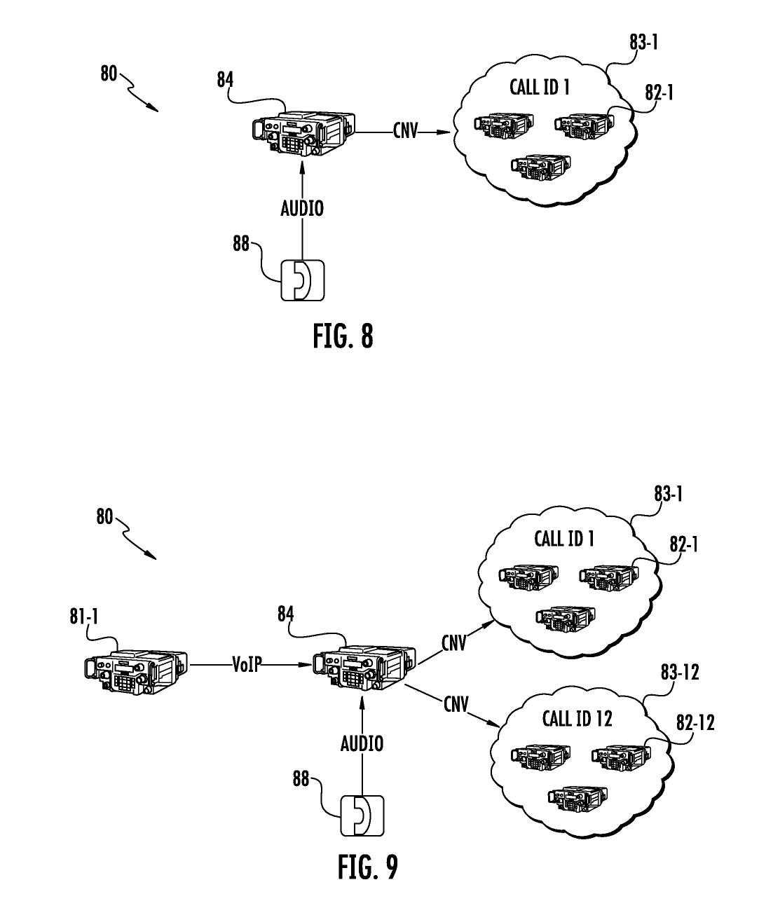

The unassigned slots may be treated as dynamic slots for incoming VoIP calls. VoIP calls from a VoIP peer 81 may include a request to be connected to a particular Call ID. The bridge radio 84 will recognize that it has an available SRW slot(s), and configure the unassigned slot to the Call ID requested. The bridge radio 84 will then automatically accept the VoIP call and patch the VoIP peer device 81-1 (and associated network, if applicable), through to the desired Call ID. The entire operation may be invisible to the local user. Thus, after the call request is received from the VoIP peer device 81 to connect to a call group 83-12 including radios 82-12 (FIG. 9), the bridge radio 84 slot assignments will be as follows:
Tx Call Group: 1
Slot 1: Call ID1
Slot 2: Call ID12
Slot 3: Unassigned
Slot 4: Unassigned
Slot 5: Unassigned

In FIG. 10, a second VoIP peer device 81-2 requests a call to a call group 83-32 including radios 82-32 on Call ID 32. Since an open slot is available, the Bridge radio 84 connects this call as well, after which the bridge radio 84 slot assignments will be as follows:
Tx Call Group: 1
Slot 1: Call ID1
Slot 2: Call ID12
Slot 3: Call ID32
Slot 4: Unassigned
Slot 5: Unassigned

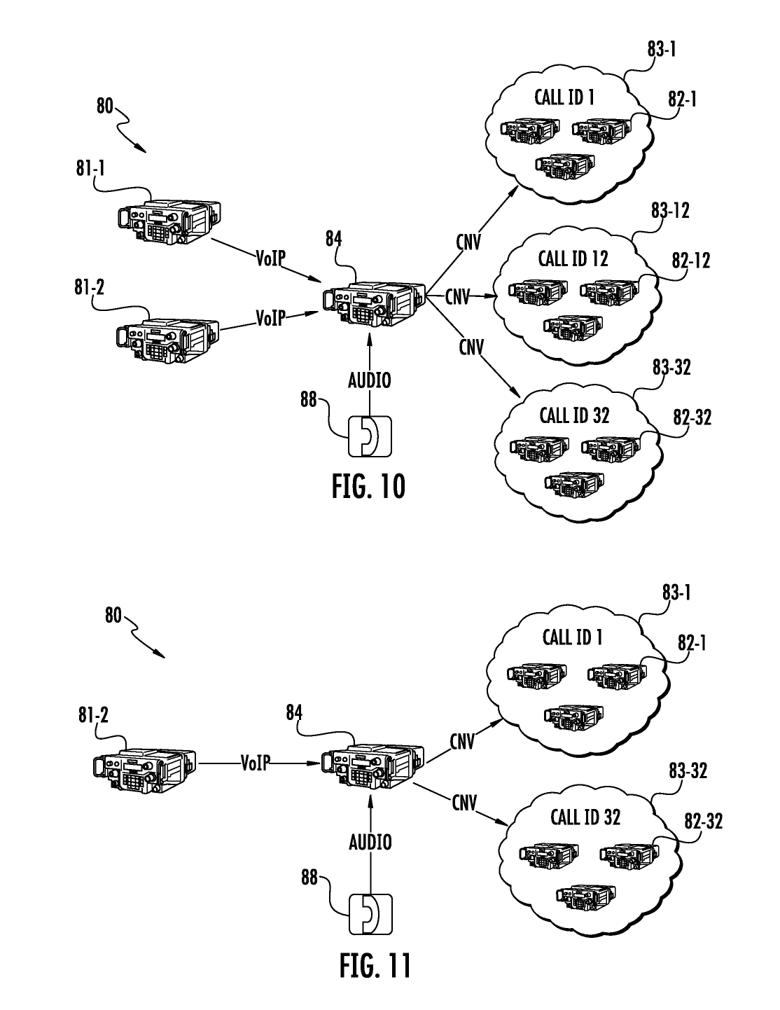

As VoIP peer devices terminate their calls, the bridge radio 84 may set the respective slots back to “unassigned” to allow their use for other VoIP peer devices. For example, in FIG. 11 the VoIP peer device 81-1 has terminated its call. As a result, the bridge radio 84 slot assignments will be as follows:
Tx Call Group: 1
Slot 1: Call ID1
Slot 2: Unassigned
Slot 3: Call ID32
Slot 4: Unassigned
Slot 5: Unassigned

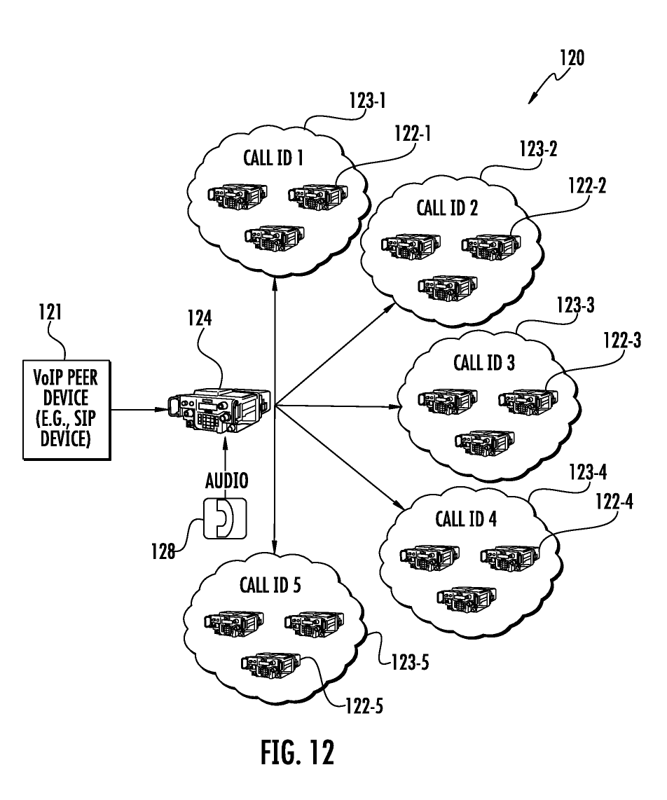

Turning now to FIGS. 12-14 and another similar communications system 120, operation of the crosstalk feature may be kept relatively simple for a radio operator. For example, when a radio operator wishes to place a call from a VoIP peer device 121 through a bridge device 124, the operator selects an option from a list or “phone book”. The phone book may include several entries, each entry corresponding to a different call group. In the present example, the bridge radio 124 is configured with five Call IDs 1-5 for call groups 123-1, 123-2, 123-3, 123-4, 123-5 including respective radios 122-1, 122-2, 122-3, 122-4, 122-5, as seen in FIG. 12, meaning there are currently no unassigned (i.e., dynamic) call slots available. The format of the identifiers in the phone book may take the form of an ID for the given call group, with an IP address of the bridge radio 124 appended to the Call ID, e.g., [Call ID]@[Bridge Radio IP Address], although other suitable call request formats may also be used. In the present case, the IP address associated with the bridge radio 124 is 192.168.1.13, and a given Call ID value (e.g., 0) may be used to designate a direct connection to the bridge radio. As such, the phone book will appear as shown in Table 1, below.

TABLE 1

| Phone Book Name | Call Result |
|---|---|
| 0@192.168.1.13 | Private call with bridge radio only |
| 1@192.168.1.13 | Call will be patched through bridge radio |
| | to Call ID1 |
| 2@192.168.1.13 | Call will be patched through bridge radio |
| | to Call ID2 |
| 3@192.168.1.13 | Call will be patched through bridge radio |
| | to Call ID3 |
| 4@192.168.1.13 | Call will be patched through bridge radio |
| | to Call ID4 |
| 5@192.168.1.13 | Call will be patched through bridge radio |
| | to Call ID5 |

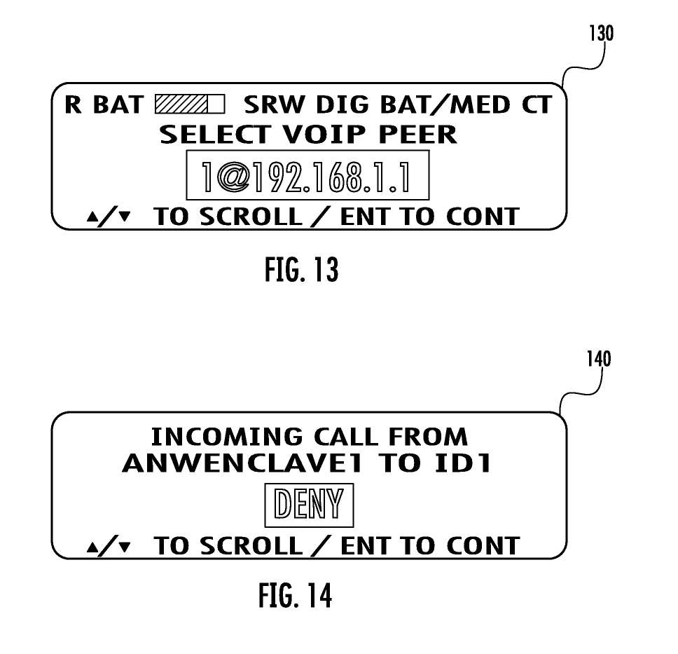

It should be noted that the bridge radio 124 does not have to allow access to all of the available call groups. For example, network planners may restrict the ability of different VoIP peer devices 121 to access certain Call IDs by intentionally leaving some of the Call IDs supported by the bridge radio 124 out of the phone book, if desired. In the example o FIG. 13, a display 130 of the VoIP peer device 121 shows a selection screen, in which a call to Call ID1 is being requested of the bridge radio 124. Moreover, if all five call ID slots are already assigned by the bridge radio 124, a call request from the VoIP peer device 121 for a different channel may be denied by the bridge radio, for example.

The bridge radio 124 may be configured to automatically accept calls from particular locations. In such case no user interaction is required at the bridge radio 124 to connect the call, as the process is automated. When user call acceptance is required, the bridge radio 124 provides a prompt to the operator, as shown on the example bridge radio display 140 illustrated in FIG. 14, indicating that a call has been requested. Here, the operator of the bridge radio 124 is given the option to deny or allow the call.

The above-described systems and methods advantageously allow for the creation of heterogeneous call groups through the use of a single bridge radio. That is, the bridge radio becomes a dynamic multi-channel retransmission station. Furthermore, the above-described dynamic channel re-allocation approach allows for VoIP peer devices to bridge to numerous different voice channels. Also, the call addressing approach described above allows for channel assignments to be automated. The above-describe approach also provides interoperability with other multi-voice group waveforms, such as P25, for example.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communications system comprising:
a Voice over IP (VoIP) device;
a plurality of radios each configured to communicate using a plurality of different radio channels; and
a bridge radio comprising
a VoIP interface configured to communicate with said VoIP device,
a radio interface configured to communicate with said radios, and
a controller coupled to said VoIP interface and said radio interface and configured to
receive a communication request from said VoIP device to communicate via a given radio channel, the communication request including an IP address associated with said bridge radio and a channel identifier associated with the given radio channel, and
bridge communications between said VoIP device and at least one of said radios over the given radio channel based upon the received communication request.

2. The communications system of claim 1 wherein said controller is configured to operate said radio interface using a subset of the plurality of radio channels, and to selectively change the subset of channels based upon the channel identifier associated with the communication request.

3. The communications system of claim 1 wherein said plurality of radios are configured in call groups, and wherein each call group shares a common radio channel so that communication therewith is party line communication.

4. The communications system of claim 1 wherein said VoIP device comprises a Session Initiation Protocol (SIP) device.

5. The communications system of claim 1 wherein said VoIP device comprises another bridge radio.

6. The communications system of claim 1 wherein said radio and said radio interface are configured to operate in a half duplex mode.

7. The communications system of claim 1 wherein the IP address is appended to the channel identifier within the communication request.

8. The communications system of claim 1 wherein the bridged communications between the VoIP device and said at least one radio comprise voice data.

9. The communications system of claim 1 wherein the bridged communications between the VoIP device and said at least one radio comprise multimedia session data.

10. The communications system of claim 1 wherein said radio and said radio interface are configured to operate using single frequency and frequency hopping modes.

11. A bridge radio comprising:
a Voice over IP (VoIP) interface configured to communicate with a VoIP device;
a radio interface configured to communicate with a plurality of radios using a plurality of different radio channels; and
a controller coupled to said VoIP interface and said radio interface and configured to
receive a communication request from the VoIP device to communicate via a given radio channel, the communication request including an IP address associated with the bridge radio and a channel identifier associated with the given radio channel, and
bridge communications between the VoIP device and at least one of the radios over the given radio channel based upon the received communication request.

12. The bridge radio of claim 11 wherein said controller is configured to operate said radio interface using a subset of the plurality of radio channels, and to selectively change the subset of channels based upon the channel identifier associated with the communication request.

13. The bridge radio of claim 11 wherein said plurality of radios are configured in call groups, and wherein each call group shares a common radio channel so that communication therewith is party line communication.

14. The bridge radio of claim 11 wherein said radio interface is configured to operate in a half duplex mode.

15. The bridge radio of claim 11 wherein the IP address is appended to the channel identifier within the communication request.

16. A method for bridging communications between a Voice over IP (VoIP) device and a plurality of radios using a plurality of different radio channels, the method comprising:
receiving, at a bridge radio, a communication request from the VoIP device to communicate via a given radio channel, the communication request including an IP address associated with the bridge radio and a channel identifier associated with the given radio channel; and
bridging communications between the VoIP device and at least one of the radios over the given radio channel using the bridge radio based upon the received communication request.

17. The method of claim 16 further comprising selectively changing a subset of channels over which the bridge radio operates based upon the channel identifier associated with the communication request.

18. The method of claim 16 further comprising configuring the plurality of radios in call groups, wherein each call group shares a common radio channel so that communication therewith is party line communication.

19. The method of claim 16 further comprising operating the bridge radio in a half duplex mode.

20. The method of claim 16 wherein the IP address is appended to the channel identifier within the communication request.
